(19) United States
(12) Patent Application Publication
(10) Pub. No.: US 2024/0105440 A1
(43) Pub. Date: Mar. 28, 2024

(54) PULSE-ASSISTED LASER-SUSTAINED PLASMA IN FLOWING HIGH-PRESSURE LIQUIDS

(71) Applicant: KLA Corporation, Milpitas, CA (US)

(72) Inventors: Ilya Bezel, Mountain View, CA (US); Oleg Khodykin, Santa Cruz, CA (US); John Szilagyi, Livermore, CA (US)

(73) Assignee: KLA Corporation, Milpitas, CA (US)

(21) Appl. No.: 18/372,590

(22) Filed: Sep. 25, 2023

Related U.S. Application Data
(60) Provisional application No. 63/410,636, filed on Sep. 28, 2022.

(51) Int. Cl. H01J 61/02; H01J 61/16; H01J 61/52; H01S 3/094

(52) U.S. Cl. CPC H01J 61/025; H01J 61/16; H01J 61/52; H01S 3/094026; H01S 3/094076; H01J 2893/0063

(57) ABSTRACT

A pulse-assisted LSP broadband light source in flowing high-pressure liquid or supercritical fluid is disclosed. The light source includes a fluid containment structure for containing a high-pressure liquid or supercritical fluid. The light source includes a primary laser pump source and a high-repetition pulse-assisting laser light source. wherein the primary laser pump source is configured to direct a primary pump beam into a plasma-forming region of the fluid. The primary beam and the pulsed-assisting beam are configured to sustain a plasma within the plasma-forming region of the fluid within the fluid containment structure. A light collector element is configured to collect broadband light emitted from the plasma for use in downstream applications.

### CROSS-REFERENCE TO RELATED APPLICATION

The present application claims priority to U.S. Provisional Application Ser. No. 63/410,636, filed Sep. 28, 2022, which is incorporated herein by reference in the entirety.

### TECHNICAL FIELD

The present invention generally relates to plasma-based radiation sources, and, more particularly, to laser sustained plasma (LSP) broadband light sources including a plasma that is pulse-assisted and formed in flowing high-pressure liquids or supercritical fluids.

### BACKGROUND

As the demand for integrated circuits having ever-smaller device features continues to increase, the need for improved illumination sources used for inspection of these ever-shrinking devices continues to grow. One such illumination source includes a laser-sustained plasma (LSP) light source. LSP light sources are capable of producing high-power broadband light. LSP light sources typically operate by focusing laser radiation into a gas volume in order to excite the gas, such as argon or xenon, into a plasma state, which is capable of emitting light. This effect is typically referred to as “pumping” the plasma. LSP used in broadband plasma (BBP) light sources is limited in brightness. Multiple methods have been suggested to increase such brightness. Specifically, fast-moving gas or liquid flow contained inside of a cell or liquid jets were proposed in an effort to increase brightness. These approaches suffer from the fact that the plasma can be quenched by fast flow of the liquid and/or gas at relatively low flow speeds in excess of about 10 m/s. Therefore, it would be desirable to provide a system and method that cure one or more shortfalls of the previous approaches identified above.

### SUMMARY

A laser-sustained plasma (LSP) broadband light source is disclosed, in accordance with one or more embodiments of the present disclosure. In illustrative embodiments, the LSP broadband light source includes a fluid containment structure for containing a fluid. In illustrative embodiments, the LSP broadband light sources includes a primary laser pump source, wherein the primary laser pump source is configured to direct a primary pump beam into a plasma-forming region of the fluid. In illustrative embodiments, the LSP broadband light sources includes a pulsed-assisting laser source, wherein the pulsed-assisting laser source is configured to direct a pulsed-assisting beam into the plasma-forming region of the fluid and the primary beam and the pulsed-assisting beam are configured to sustain a plasma within the plasma-forming region of the fluid within the fluid containment structure. In illustrative embodiments, the LSP broadband light source includes a light collector element configured to collect at least a portion of broadband light emitted from the plasma. In illustrative embodiments, the LSP broadband light source may be implemented within an optical system such as, but not limited to, an inspection system, a metrology system, or a lithography system.

An LSP broadband light source is disclosed, in accordance with one or more additional and/or alternative embodiments of the present disclosure. In illustrative embodiments, the LSP broadband light sources includes a fluid containment structure. In illustrative embodiments, the LSP broadband light sources includes a plurality of jet nozzles, wherein the plurality of jet nozzles are configured to direct a plurality of fluid jets to collide within the fluid containment structure, wherein the plurality of fluid jets include a first fluid jet and at least a second fluid jet. In illustrative embodiments, the LSP broadband light sources includes a primary laser pump source, wherein the primary laser pump source is configured to direct a primary pump beam at a collision point of the plurality of fluid jets. In illustrative embodiments, the LSP broadband light sources includes a pulsed-assisting laser source, wherein the pulsed-assisting laser source is configured to direct a pulsed-assisting beam at the collision point of the plurality of fluid jets, wherein the primary beam and the pulsed-assisting beam are configured to sustain a plasma within a plasma-forming region of the fluid containment structure at the collision point of the plurality of fluid jets. In illustrative embodiments, the LSP broadband light sources includes a light collector element configured to collect at least a portion of broadband light emitted from the plasma. In illustrative embodiments, the LSP broadband light source may be implemented within an optical system such as, but not limited to, an inspection system, a metrology system, or a lithography system.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures.

FIGS. 1A-1B illustrate a conceptual view of a pulse-assisted LSP broadband light source in a flowing fluid, in accordance with one or more embodiments of the present disclosure.

FIG. 1C illustrates the laser intensity of the pulsed-assisting laser output and the corresponding broadband emission of the generated plasma where overlap between pulses of the broadband emission occurs, in accordance with one or more embodiments of the present disclosure.

FIG. 1D illustrates the laser intensity of the pulsed-assisting laser output and the corresponding broadband emission of the generated plasma where overlap between pulses of the broadband emission does not occur, in accordance with one or more embodiments of the present disclosure.

FIG. 1E illustrates a simplified schematic view of the pulse-assisted LSP broadband light source where the optical path of the pump beam does not overlap with the optical path of the pulse-assisting beam, in accordance with one or more embodiments of the present disclosure.

FIG. 1F illustrates a simplified schematic view of the pulse-assisted LSP broadband light source where the optical path of the pump beam overlaps with the optical path of the pulse-assisting beam through the use of a dichroic mirror, in accordance with one or more embodiments of the present disclosure.

FIG. 1G illustrates a simplified schematic view of the pulse-assisted LSP broadband light source where the pulse-assisting beam is injected into a laser fiber of the primary pump source, in accordance with one or more embodiments of the present disclosure.

FIG. 2A illustrates a conceptual view of the LSP broadband light source with a liquid jet for supplying plasma-generating material, in accordance with one or more embodiments of the present disclosure.

FIG. 2B illustrates a conceptual view of the LSP broadband light source with two colliding liquid jets for supplying plasma-generating material, in accordance with one or more embodiments of the present disclosure.

FIG. 3 illustrates a simplified schematic view of an optical characterization system implementing the pulse-assisted LSP broadband light source, in accordance with one or more embodiments of the present disclosure.

FIG. 4 illustrates a flow diagram depicting a method of generating broadband light in a flowing fluid with a primary pump beam and a pulsed-assisting pump beam, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

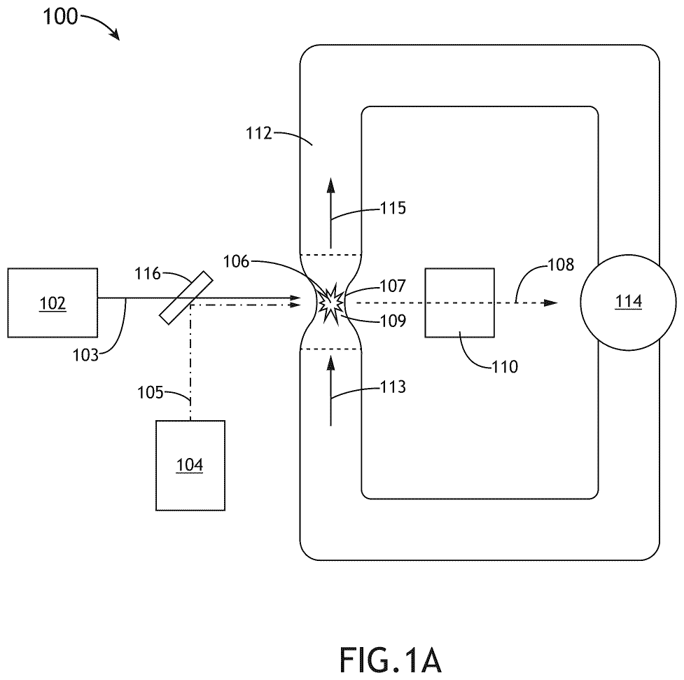

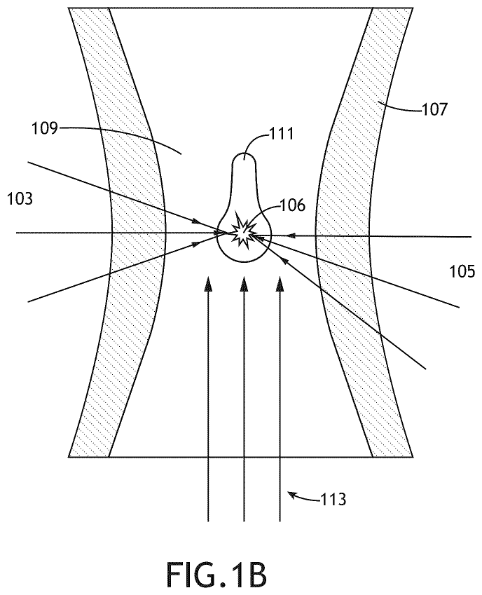

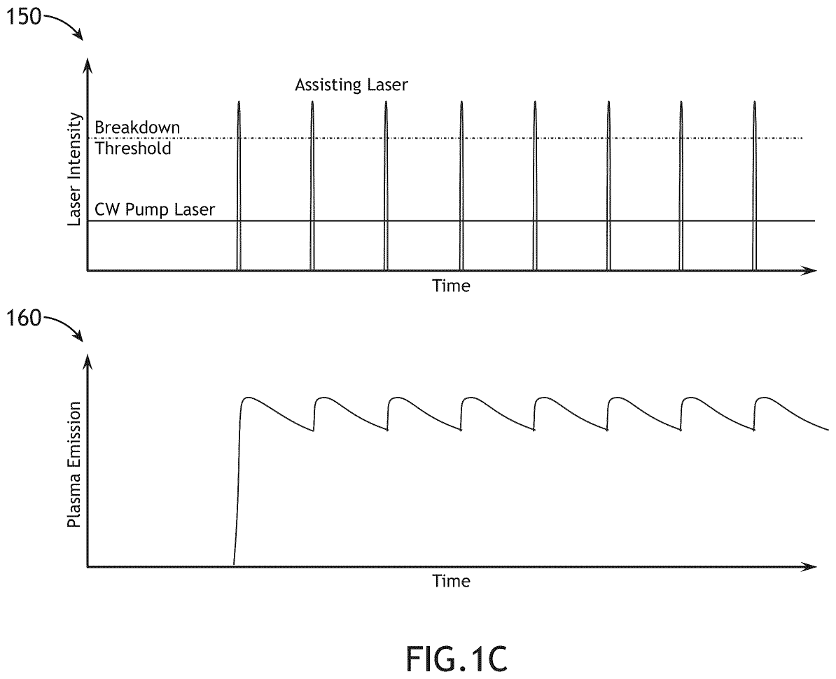

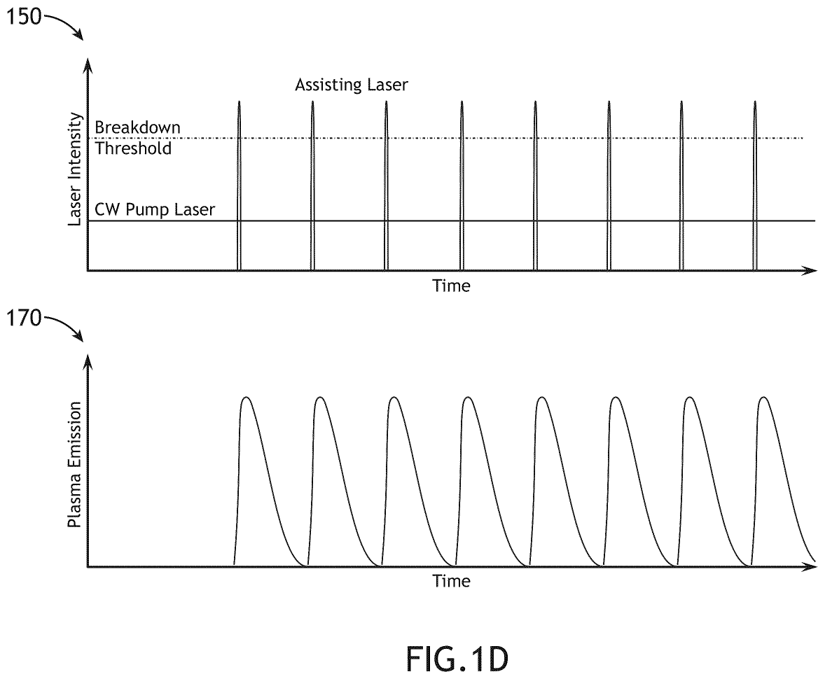

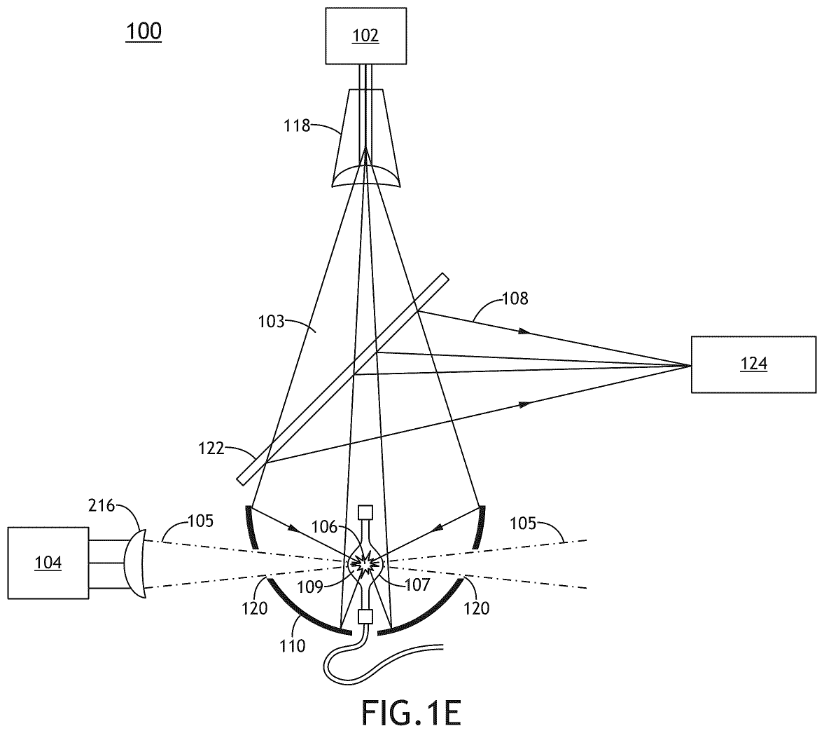

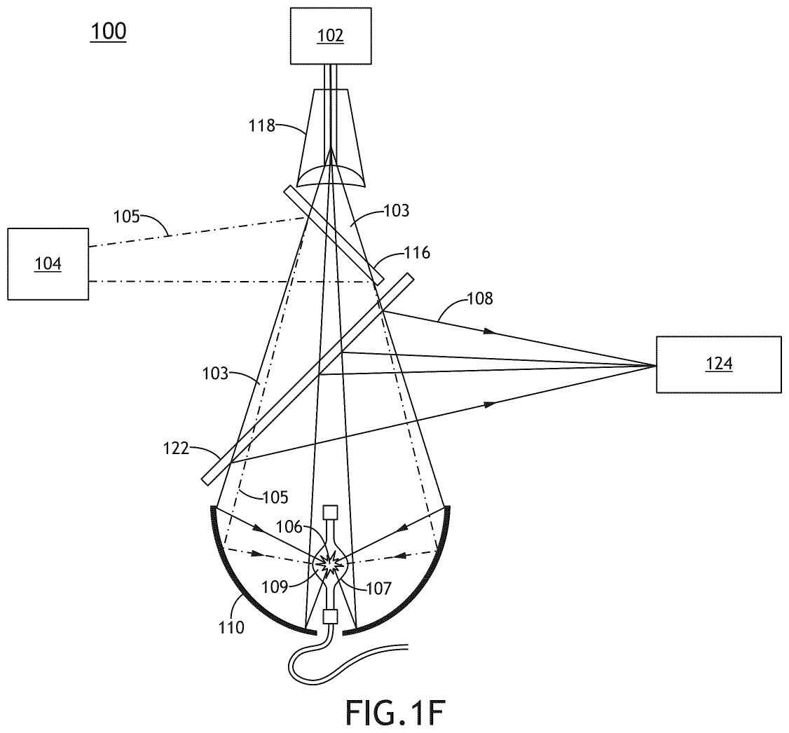

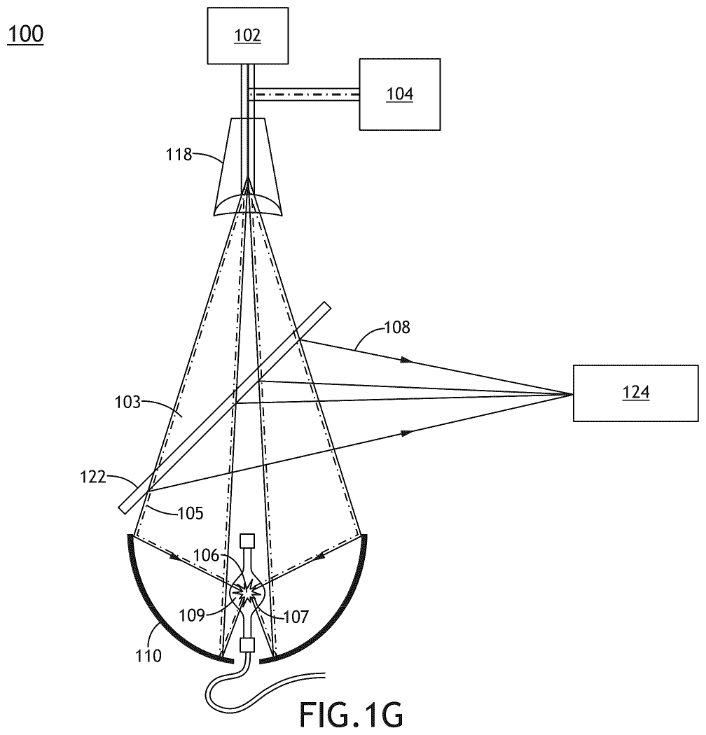

Referring generally to FIGS. 1A-3, a broadband light source including a pulse-assisted laser-sustained plasma in flowing high-pressure liquid is described, in accordance with one or more embodiments of the present disclosure.

Embodiments of the present disclosure are directed to operation of an LSP broadband source by augmenting the pump laser power with a high-repetition pulsed-assisting laser beam to sustain the LSP in a flowing high-pressure liquid or supercritical fluid. Specifically, embodiments of the present disclosure may sustain the plasma in flowing high-pressure liquid or supercritical fluid by using laser sources that are intense enough to form self-sustained liquid breakdown. The high laser intensity required for self-breakdown is achieved by adding a second, high repetition rate short pulse assisting laser. The plasma may then be sustained by a high-power primary pump laser such as a continuous wave (CW) laser. The liquid is maintained under high pressure inside a fluid containment structure (e.g., cell, bulb, chamber) that also guides the fluid flow through the plasma region.

FIGS. 1A and 1B illustrate a pulse-assisted broadband LSP light source 100, in accordance with one or more embodiments of the present disclosure. In embodiments, the pulse-assisted broadband LSP light source 100 includes a fluid containment structure 107 to contain fluid 109 (e.g., high-pressure liquid or supercritical fluid), a primary laser pump source 102, a pulsed-assisting laser source 104, and a light collector element 110. In additional and/or alternative embodiments, the broadband LSP light source 110 includes a recirculation loop 112.

As shown in FIG. 1B, in embodiments, the fluid containment structure 107 contains fluid 109. For example, the fluid containment structure 107 may include a transparent fluid containment structure 107 configured for containing fluid 109. The fluid containment structure 107 may include a transparent cell, a transparent bulb, or a chamber with one or more transparent windows. In embodiments, the fluid containment structure 107 may have a concave profile such that fluid passing through the plasma-forming region of the fluid containment structure 107 is constricted, thereby increasing fluid velocity and pressure. The fluid 109 may include, but is not limited to, a high-pressure gas or supercritical fluid. In embodiments, the recirculation loop 112 may flow fluid 109 through the fluid containment structure 107. In embodiments, the recirculation loop 112 includes recirculation pump 114 to recirculate fluid through the recirculation loop 112. In this regard, the recirculation loop 112 may provide cool fluid 113 to the input of the fluid containment structure 107 and carry away hot fluid 115 from the output of the fluid containment structure 107.

In embodiments, the primary laser pump source 102 directs a primary pump beam 103 into a plasma-forming region of the fluid 109 and the assisting laser source 104 directs a pulsed-assisting beam 105 into the plasma-forming region of the fluid 109. In embodiments, the primary beam 103 and the pulsed-assisting beam 105 sustain plasma 106 within the plasma-forming region of the fluid 109 within the fluid containment structure 107. In embodiments, the primary beam 103 and pulsed-assisting beam 105 may provide instantaneous pump power above the liquid-to-gas breakdown threshold of the fluid 109 sufficient to form gas cavity 111 within the fluid 109 of the fluid containment structure 107, with plasma 106 sustained within gas cavity 111. It is noted the recirculation pump 114 may drive fluid 109 (e.g., high-pressure liquid or supercritical fluid) through the fluid containment structure 107 at a flow rate sufficient to quench a CW-pumped plasma (without the assisting-pulsed laser 104).

The primary laser pump source 102 may include any laser pump source known in the art. In embodiments, the primary laser pump source 102 may include one or more continuous wave (CW) lasers. For example, the primary laser pump source 102 may include, but is not limited to, one or more fiber-based near-infrared (NIR) lasers, one or more direct photodiode lasers, and/or one or more CO₂ lasers. The primary laser pump source 102 may operate at high power at a power greater than 5 kW (e.g., greater than 10 kW).

The pulsed-assisting laser source 104 may include any pulsed laser source known in the art. In embodiments, the pulsed-assisting laser source 104 may include one or more picosecond or femtosecond pulsed laser sources. The pulsed-assisting laser source 104 may include, but is not limited to, one or more pulsed fiber-based NIR lasers, one or more pulsed coherently coupled fiber lasers, and/or one or more pulsed think disk lasers. The one or more pulsed-assisting laser sources 104 may operate at a repetition rate greater than about 50 kHz (e.g., greater than 100 kHz). For example, one or more pulsed-assisting laser sources 104 may operate at a repetition rate greater than 1 MHz. The one or more pulsed lasers may operate at a power above approximately 25 W (e.g., above 50 W) which is used to increase the instantaneous power near the focus to above the liquid-to-gas breakdown threshold of the plasma 106.

In embodiments, light source 100 includes one or more focusing optics for focusing/directing the primary pump beam 103 to the plasma 106. In addition, light source 100 may include one or more focusing optics for focusing/directing the pulsed-assisting beam 105 to the plasma 106. The one or more focusing optics may include any optical element known in the art for directing and/or focusing laser light including, but not limited to, a lens, a mirror, a prism, a polarizer, a grating, a filter, or a beamsplitter. In additional and/or alternative embodiments, the one or more focusing optics of the primary pump beam 103 and/or the pulsed-assisting beam 105 may be compensated. For example, the one or more focusing optics (e.g., 214 or 216 in FIGS. 1E-1G) may be compensated to correct for aberrations caused by the light transmitting portions of the fluid containment structure 107 (e.g., cell, bulb, or window of chamber).

By way of non-limiting example, during operation, the instantaneous pump power of the light source 100 may be maintained above the liquid-to-gas breakdown threshold of the fluid by either increasing the primary pump laser power to about 100 kW with the focus spot of about 100 μm or by adding the pulsed-assisting laser source 104 that has instantaneous intensity high enough to ensure liquid-to-gas breakdown. The typical instantaneous intensity required to achieve liquid-to-gas breakdown is above about 10¹¹-10¹³ W/cm². In embodiments, the pulsed-assisting laser source 104 repetition rate may be sufficiently high so that the plasma does not quench completely between the pulses. In embodiments, the plasma quenching time may be about 1 μs. In this example, the repetition rate may be selected above about 1 MHz. The pulse width of the pulsed-assisting laser 104 may be selected to be about 1-10 ps for lower repetition rates but may be selected in the 100 fs range for repetition rates of about 1 GHz. Such a configuration allows the required breakdown threshold power to be attained even at relatively modest pulsed-assisted laser energies of about 50-100 W of average power in the focal spot of about 100 μm. The resulting plasma 106 absorbs the power from the primary pump laser, which provides the primary power source for the plasma 106. In the event the power of the primary pump laser 102 is insufficient to reach the 10¹¹-10¹³ W/cm² breakdown intensity at the focal spot, the plasma 106 will be quenched by the cold liquid/gas flow provided to the fluid containment structure 107. With the utilization of the pulsed-assisting laser 104, the plasma discharge is sustained regardless of the fluid flow rate. In embodiments, the pressure inside the fluid may be maintained above about 100 bar in order to ensure high brightness. This can be accomplished by pressurizing the fluid 109 in the fluid containment structure 107. In embodiments, the flow rate through the fluid containment structure 107 may be about 10 m/s.

It is noted that the various parameters of the light source 100 described in the non-limiting example should not be interpreted as limitations on the scope of the present disclosure. Rather, these examples are provided merely for illustration purposes and it should be understood that various laser powers, frequency, pulse durations, fluid pressure, and fluid velocity may be utilized given the particulars of the light source 100 in operation.

The fluid 109 contained by and circulated through the fluid containment structure 107 may include a liquid or a supercritical fluid. For example, fluid 109 may include, but is not limited to, water, ammonia, organic solvents, and the like. In addition, fluid 109 may include one or more cryogenic liquids including, but not limited to, liquid Ne, Ar, Kr, Xe, N₂, O₂, and the like. In embodiments, fluid 109 may include a mixture of two or more fluids. For example, fluid 109 may include a mixture of any two or more liquids or supercritical fluids discussed herein.

In embodiments, fluid 109 may be maintained at pressure and temperature conditions beyond critical conditions such that the fluid 109 is a supercritical fluid. For example, the fluid 109 may include Ar at a temperature greater than about 151 K and/or a pressure greater than 49 bar. By way of another example, the fluid 109 may include Kr at a temperature greater than about 209 K and/or a pressure greater than 55 bar. Similarly, the mixture of gases above critical conditions may also be used. In the case of liquid, a liquid-gas interface between the plasma and cold liquid occurs. This interface may result in additional reflection losses and also in refraction of the pump laser light. The shape of interface may be affected by processes occurring downstream from the plasma such as, but not limited to, cavitation—collapse of the gas bubbles. If the liquid is maintained at supercritical conditions, no such interface is formed.

In embodiments, fluid 109 may be maintained near the critical point of the fluid. For example, the fluid 109 may be maintained under conditions where the fluid 109 is a liquid upstream from the plasma 106 but becomes supercritical fluid (liquid-gas) downstream from the plasma 106, where the temperature is higher due to heat released from the plasma region.

In embodiments, the light collector element 110 is configured to collect broadband light 108 emitted from the plasma 106. The light collector element 110 may include any one or more optical elements known in the art configured to collect and/or focus broadband light 108 including, but not limited to, one or more mirrors, one or more prisms, one or more lenses, one or more diffractive optical elements, one or more parabolic mirrors, one or more elliptical mirrors, one or more spherical mirrors and the like. It is recognized herein that the light collector element 110 may be configured to collect and/or focus broadband light 108 generated by plasma 106 to be used for one or more downstream processes including, but not limited to, imaging processes, inspection processes, metrology processes, lithography processes, and the like.

FIG. 1C depicts laser intensity 150 and plasma emission 160 as a function of time to illustrate the plasma dynamics in the case where the pulse-assisted laser source 104 assists a CW laser source with modulation of the plasma emission, in accordance with one or more embodiments of the present disclosure. In this embodiment, the primary CW pump laser, at the focus, is below the liquid-to-gas breakdown threshold. The intensity of the pumped-assisting laser source is above the liquid-to-gas breakdown threshold. In this embodiment, the plasma emission response is partially modulated between the laser pulses of the pulsed-assisting laser source but provides a steady broadband output due to the continuous absorption of power from the CW pump laser.

FIG. 1D depicts laser intensity 150 and plasma emission 170 as a function of time to illustrate the plasma dynamics in the case where the pulse-assisted laser source 104 assists a CW laser source with no overlap between plasma emission pulses, in accordance with one or more embodiments of the present disclosure. In this embodiment, the primary CW pump laser, at the focus, is below the liquid-to-gas breakdown threshold. The intensity of the pumped-assisting laser source is above the liquid-to-gas breakdown threshold. In this embodiment, the plasma emission is not continuous, and the plasma emission pulses do not overlap or are on the verge of overlapping.

FIG. 1E illustrates a simplified schematic diagram of the broadband LSP light source 100, in accordance with one or more embodiments of the present disclosure. It is noted herein that the various embodiments described with respect to FIGS. 1A-1D should be interpreted to extend to the embodiments of FIG. 1D. In this embodiment, the light collector element 110 is a curved mirror 110. For example, the light collector element 110 may include, but is not limited to, an elliptical, spherical, or parabolic mirror. In embodiments, the primary pump beam 103 and the pump-assisting beam 105 do not share an optical path prior to entry into the light collector element 110. For example, the primary pump source 102 may direct the pump beam 103 through pump module including one or more laser-shaping optics 118. In turn, the pump beam 103 passes through the dichroic mirror 122 (e.g., cold mirror) and is directed toward the fluid 109 within the fluid containment structure 107. In addition, the pulsed-assisting source 104 may be arranged so as to direct the pulsed-assisting beam 105 through one or more side ports 120 formed through the sidewall of the light collector element 110 and into the fluid 109 contained within the fluid containment structure 107. As described previously herein, pump beam 103 and pulsed-assisting beam 105 act to sustain the plasma 106. Broadband light 108 emitted by plasma 106 may then be collected by the light collection element 110 and directed by the dichroic mirror 122 to one or more downstream optical elements. For example, the dichroic mirror 122 may direct the broadband illumination 108 to a homogenizer 124.

FIG. 1F illustrates a simplified schematic diagram of the broadband LSP light source 100, in accordance with one or more embodiments of the present disclosure. It is noted herein that the various embodiments described with respect to FIGS. 1A-1E should be interpreted to extend to the embodiments of FIG. 1F. In this embodiment, the primary pump beam 103 and the pump-assisting beam 105 share an optical path prior to entry into the light collector element 110 (e.g., elliptical, spherical, or parabolic mirror). For example, the primary pump source 102 may direct the pump beam 103 through pump module including one or more laser-shaping optics 118. In turn, the primary pump beam 103 passes through the dichroic mirror 122 (e.g., cold mirror) and is directed toward the fluid 109 within the fluid containment structure 107. In addition, the pulsed-assisting source 104 may be arranged so as to direct the pulsed-assisting beam 105 to a first dichroic mirror 116. The first dichroic mirror 116 is configured to transmit the primary pump beam 103 toward the light collector element 110 while reflecting the pulsed-assisting beam 105 toward the light collector element 110. Following the first dichroic mirror 116 the primary pump beam 103 and the pulsed-assisting beam 105 share an optical path to the light collector element 110. The primary pump beam 103 and the pulsed-assisting beam 105 may then pass through the second dichroic mirror 122 and are reflected by the light collector element 110 into the fluid 109 contained within the fluid containment structure 107. As described previously herein, pump beam 103 and pulsed-assisting beam 105 act to sustain the plasma 106. Broadband light 108 emitted by plasma 106 may then be collected by the light collection element 110 and directed by the dichroic mirror 122 to one or more downstream optical elements (e.g., homogenizer 124).

FIG. 1G illustrates a simplified schematic diagram of the broadband LSP light source 100, in accordance with one or more embodiments of the present disclosure. It is noted herein that the various embodiments described with respect to FIGS. 1A-1F should be interpreted to extend to the embodiments of FIG. 1G. In this embodiment, pump-assisting beam 105 is injected into one or more laser fibers of the primary pump source 102 for the primary pump beam 103. As a result, the primary pump beam 103 and pump-assisting beam 105 share an optical path as the beams 103, 105 exit the beam-shaping optics 118. Upon exiting the beam-shaping optics 118, the primary pump beam 103 and the pulsed-assisting beam 105 are directed through the dichroic mirror 122 (e.g., cold mirror) toward the light collector element 110 which, in turn, directs the primary bump beam 103 and the pulsed-assisting beam 105, which share an optical path, to fluid 109 within the fluid containment structure 107. As described previously herein, pump beam 103 and pulsed-assisting beam 105 act to sustain the plasma 106. Broadband light 108 emitted by plasma 106 may then be collected by the light collector element 110 and directed by the dichroic mirror 122 to one or more downstream optical elements (e.g., homogenizer 124).

While much of the present disclosure has focused on the operation of the broadband light source 100 using a flowing high-pressure gas or supercritical fluid through a transparent plasma cell or build, such a configuration is not a limitation on the scope of the present disclosure. It is recognized herein that the utilization of the pulsed-assisting source 104 and the corresponding high-repetition pulse-assisting beam 105 may be implemented in the context of any high-pressure liquid or supercritical fluid.

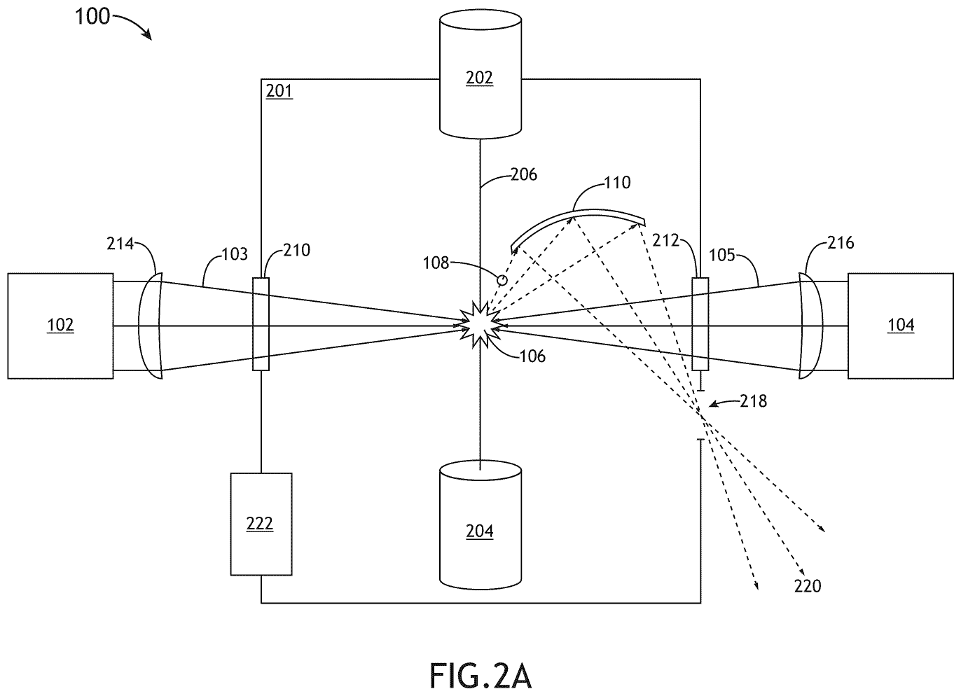

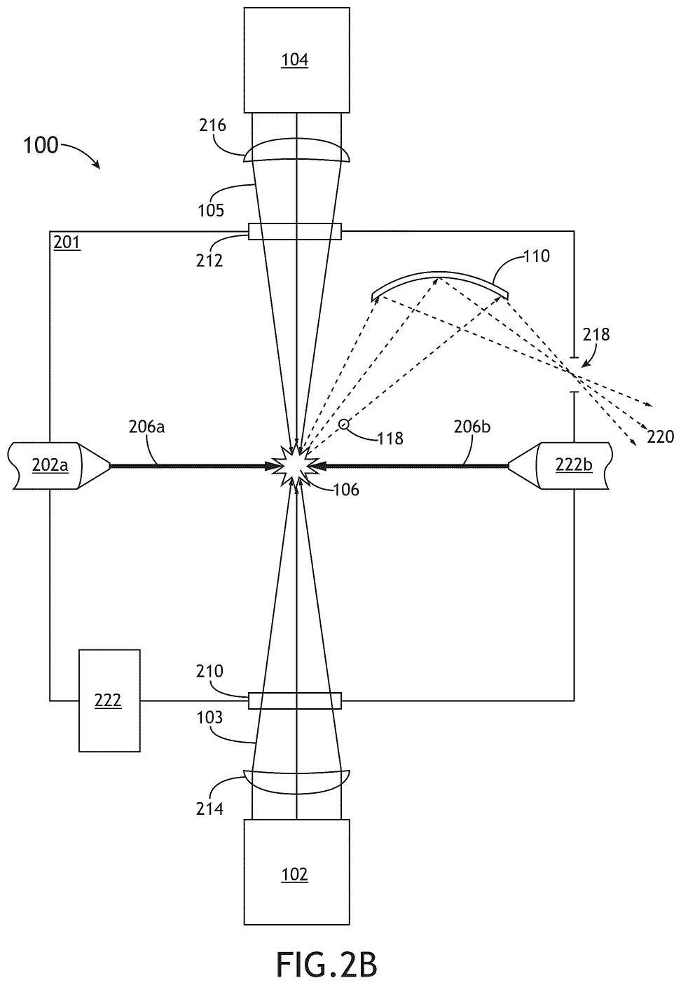

FIG. 2A illustrates the broadband LSP light source 100, in accordance with one or more additional and/or alternative embodiments. In this embodiment, one or more liquid jets are utilized to create a localized region of high pressure in the target liquid. In embodiments, light source 100 includes a target material source 202, the primary pump source 102, primary pump focusing optics 214, the pulsed-assisting laser source 104, pulsed-assisting focusing optics 216, and the set of collection optics 110. In embodiments, the LSP source 100 includes a debris collector 204.

In embodiments, the target material source 202 delivers one or more target materials 206 into chamber 201. For example, the target material source 202 may introduce one or more target materials 206 into chamber 201 in the form of a liquid jet, liquid droplets, a frozen jet, frozen droplets, or a combination of these target material forms. In embodiments, the stream delivery parameters of target material 206 from the target material source 202 are adjusted such that either all material delivered by the target material source 202 evaporates in the plasma region or some of the material passes through the plasma and is collected by the debris collector 204. In embodiments, the debris collector 204 is positioned on a side of the chamber opposite the target material source 202. The target material source 202 may deliver any type of target material known in the art of LSP broadband sources. For example, the target material may include, but is not limited to, liquid, super critical, or solid Ar, Xe, Ne, He, Kr, N2, O2, H₂O, ammonia, organic solvents and the like. The target material may also include a mixture of two or more of the materials listed herein.

In embodiments, the pump laser focusing optics 214 focus the pump beam 103 through a pump laser window 210 into chamber 201. In embodiments, the pump laser focusing optics 214 focus the pump beam 103 into one or more target materials 206 so as to generate and/or sustain the plasma 106. Similarly, pulsed-assisting optics 216 focus the pulsed-assisting beam 105 through a pulsed-assisting laser window 212 into chamber 201. In embodiments, the pulsed-assisting laser focusing optics 216 focus the pulsed-assisting beam 105 into one or more target materials 206. In this regard, the pump beam and the pulsed-assisting beam generate and/or sustain the plasma 106 in a manner as discussed previously herein to generate broadband light 108. The broadband light 108 may be collected by collector optical element 110 and directed through one or more apertures 218 to one or more downstream applications 220. It is noted herein that the pump laser focusing optics 214 and the pulsed-assisting laser optics 216 may include any optical element known in the art for directing and/or focusing radiation including, but not limited to, a lens, a mirror, a prism, a polarizer, a grating, a filter, or a beamsplitter.

The general architecture for implementing a broadband light source with one or more liquid jets to create a localized region of high pressure is discussed in U.S. Pat. No. 10,806,016, filed on Jul. 16, 2018, which is incorporated herein by reference in the entirety.

FIG. 2B illustrates the broadband LSP light source 100, in accordance with one or more additional and/or alternative embodiments. In this embodiment, two or more liquid jets are utilized to create a high density, low velocity stable gas region at the point of their collision. At this point of collision, plasma 106 may be generated by focusing the primary pump beam 103 and the pulse-assisting beam 105 to this point. The colliding jets create a high density, low velocity stable gas region at the point of their collision. The velocity at the point of the collision approaches zero. Having a near-zero velocity region helps guarantee plasma sustainability at lower pump power. In embodiments, light source 100 a set of jet nozzles 202a, 202b, the primary pump source 102, primary pump focusing optics 214, the pulsed-assisting laser source 104, pulsed-assisting focusing optics 216, and the light collector element 110. The set of jet nozzles may include a first jet nozzle 202a and a second jet nozzle 202b for delivering target material jets 206a, 206b, respectively, to collide within the gas containment structure 206 (e.g., chamber, lamp, or cell). In embodiments, the pump laser focusing optics 214 focus the pump beam 103 tot the collision point between the first liquid jet stream 206a and the second liquid jet stream 206b and the pulsed-assisting laser focusing optics 216 focus the pulsed-assisting beam 105 to the collision point between the first liquid jet stream 206a and the second liquid jet stream 206b so as to generate and/or sustain a plasma 106. In this regard, the pump beam and the pulsed-assisting beam generate and/or sustain plasma 106 in a manner as discussed previously herein to generate broadband light 108. The material within stream 206a and 206b may include, but is not limited to, liquid, super critical, or solid Ar, Xe, Ne, He, Kr, N2, O2, H₂O, ammonia, organic solvents and the like. The material may also include a mixture of two or more of the materials listed herein. The broadband light 108 may be collected by collector optical element 110 and directed through one or more apertures 218 to one or more downstream applications 220. It is noted herein that the pump laser focusing optics 214 and the pulsed-assisting laser optics 216 may include any optical element known in the art for directing and/or focusing radiation including, but not limited to, a lens, a mirror, a prism, a polarizer, a grating, a filter, or a beamsplitter.

The general architecture for implementing a broadband light source with two or more liquid jets colliding jets to create a localized region of high pressure and low velocity is discussed in U.S. patent application Ser. No. 18/132,162, filed on Apr. 7, 2023, which is incorporated herein by reference in the entirety.

The generation of a laser-sustained plasma is also generally described in U.S. Pat. No. 7,435,982, issued on Oct. 14, 2008, which is incorporated by reference herein in the entirety. The generation of plasma is also generally described in U.S. Pat. No. 7,786,455, issued on Aug. 31, 2010, which is incorporated by reference herein in the entirety. The generation of plasma is also generally described in U.S. Pat. No. 7,989,786, issued on Aug. 2, 2011, which is incorporated by reference herein in the entirety. The generation of plasma is also generally described in U.S. Pat. No. 8,182,127, issued on May 22, 2012, which is incorporated by reference herein in the entirety. The generation of plasma is also generally described in U.S. Pat. No. 8,309,943, issued on Nov. 13, 2012, which is incorporated by reference herein in the entirety. The generation of plasma is also generally described in U.S. Pat. No. 8,525,138, issued on Feb. 9, 2013, which is incorporated by reference herein in the entirety. The generation of plasma is also generally described in U.S. Pat. No. 8,921,814, issued on Dec. 30, 2014, which is incorporated by reference herein in the entirety. The generation of plasma is also generally described in U.S. Pat. No. 9,318,311, issued on Apr. 19, 2016, which is incorporated by reference herein in the entirety. The generation of plasma is also generally described in U.S. Pat. No. 9,390,902, issued on Jul. 12, 2016, which is incorporated by reference herein in the entirety. In a general sense, the various embodiments of the present disclosure should be interpreted to extend to any plasma-based light source known in the art.

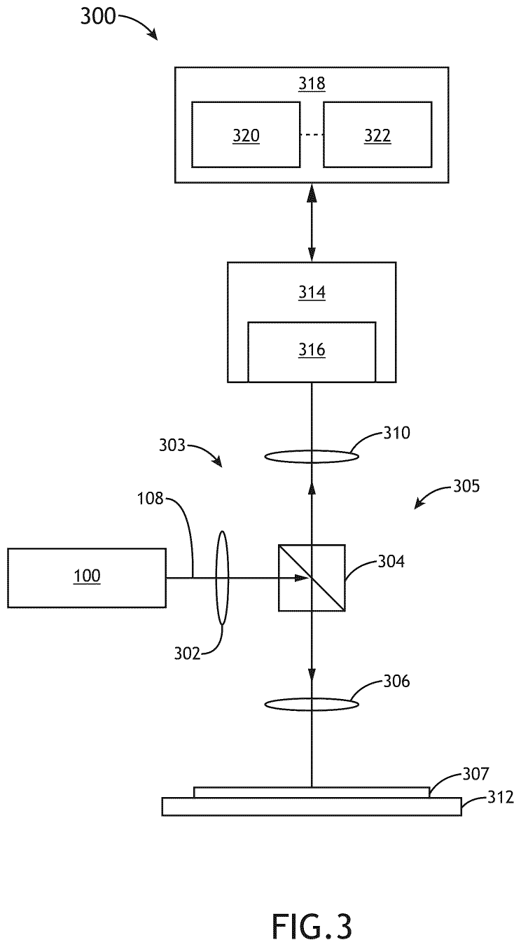

FIG. 3 illustrates a simplified schematic view of an optical characterization system 300 implementing the LSP broadband light source 100, in accordance with one or more embodiments of the present disclosure. In one embodiment, system 300 includes the LSP light source 100, an illumination arm 303, a collection arm 305, a detector assembly 314, and a controller 318 including one or more processors 320 and memory 322.

It is noted herein that system 300 may comprise any imaging, inspection, metrology, lithography, or other characterization system known in the art. In this regard, system 300 may be configured to perform inspection, optical metrology, lithography, and/or any form of imaging on a sample 307. Sample 307 may include any sample known in the art including, but not limited to, a wafer, a reticle, a photomask, and the like. It is noted that system 300 may incorporate one or more of the various embodiments of the LSP light source 100 described throughout the present disclosure.

In one embodiment, sample 307 is disposed on a stage assembly 312 to facilitate movement of sample 307. Stage assembly 312 may include any stage assembly 312 known in the art including, but not limited to, an X-Y stage, an R-θ stage, and the like. In another embodiment, stage assembly 312 is capable of adjusting the height of sample 307 during inspection or imaging to maintain focus on sample 307.

In one embodiment, the illumination arm 303 is configured to direct broadband light 118 from the Broadband LSP light source 100 to the sample 307. The illumination arm 303 may include any number and type of optical components known in the art. In one embodiment, the illumination arm 303 includes one or more optical elements 302, a beam splitter 304, and an objective lens 306. In this regard, illumination arm 303 may be configured to focus broadband light 118 from the Broadband LSP light source 100 onto the surface of the sample 307. The one or more optical elements 302 may include any optical element or combination of optical elements known in the art including, but not limited to, one or more mirrors, one or more lenses, one or more polarizers, one or more gratings, one or more filters, one or more beam splitters, and the like. It is noted herein that the collection location 128 may include, but is not limited to, one or more of the optical elements 302, a beam splitter 304, or an objective lens 306.

In one embodiment, system 300 includes a collection arm 305 configured to collect light reflected, scattered, diffracted, and/or emitted from sample 307. In another embodiment, collection arm 305 may direct and/or focus the light from the sample 307 to a sensor 316 of a detector assembly 314. It is noted that sensor 316 and detector assembly 314 may include any sensor and detector assembly known in the art. The sensor 316 may include, but is not limited to, a CCD sensor or a CCD-TDI sensor. Further, sensor 316 may include, but is not limited to, a line sensor or an electron-bombardment line sensor.

In one embodiment, detector assembly 314 is communicatively coupled to a controller 318 including one or more processors 320 and memory 322. For example, the one or more processors 320 may be communicatively coupled to memory 322, wherein the one or more processors 320 are configured to execute a set of program instructions stored on memory 322. In one embodiment, the one or more processors 320 are configured to analyze the output of detector assembly 314. In one embodiment, the set of program instructions are configured to cause the one or more processors 320 to analyze one or more characteristics of sample 307. In another embodiment, the set of program instructions are configured to cause the one or more processors 320 to modify one or more characteristics of system 300 in order to maintain focus on the sample 307 and/or the sensor 316. For example, the one or more processors 320 may be configured to adjust the objective lens 306 or one or more optical elements 302 in order to focus broadband light 118 from broadband LSP light source 100 onto the surface of the sample 307. By way of another example, the one or more processors 320 may be configured to adjust the objective lens 306 and/or one or more optical elements 310 in order to collect illumination from the surface of the sample 307 and focus the collected illumination on the sensor 316.

It is noted that the system 300 may be configured in any optical configuration known in the art including, but not limited to, a dark-field configuration, a bright-field orientation, and the like. The system 300 may be configured as any type of metrology tool known in the art such as, but not limited to, a spectroscopic ellipsometer with one or more angles of illumination, a spectroscopic ellipsometer for measuring Mueller matrix elements (e.g., using rotating compensators), a single-wavelength ellipsometer, an angle-resolved ellipsometer (e.g., a beam-profile ellipsometer), a spectroscopic reflectometer, a single-wavelength reflectometer, an angle-resolved reflectometer (e.g., a beam-profile reflectometer), an imaging system, a pupil imaging system, a spectral imaging system, or a scatterometer.

Additional details of various embodiments of optical characterization system 300 are described in U.S. Pat. No. 7,957,066B2, entitled “Split Field Inspection System Using Small Catadioptric Objectives,” issued on Jun. 7, 2011; U.S. Published Patent Application 2007/0002465, entitled “Beam Delivery System for Laser Dark-Field Illumination in a Catadioptric Optical System,” published on Jan. 4, 2007; U.S. Pat. No. 5,999,310, entitled “Ultra-broadband UV Microscope Imaging System with Wide Range Zoom Capability,” issued on Dec. 7, 1999; U.S. Pat. No. 7,525,649 entitled “Surface Inspection System Using Laser Line Illumination with Two Dimensional Imaging,” issued on Apr. 28, 2009; U.S. Published Patent Application 2013/0114085, entitled “Dynamically Adjustable Semiconductor Metrology System,” by Wang et al. and published on May 9, 2013; U.S. Pat. No. 5,608,526, entitled “Focused Beam Spectroscopic Ellipsometry Method and System, by Piwonka-Corle et al., issued on Mar. 4, 1997; and U.S. Pat. No. 6,297,880, entitled “Apparatus for Analyzing Multi-Layer Thin Film Stacks on Semiconductors,” by Rosencwaig et al., issued on Oct 2, 2001, which are each incorporated herein by reference in their entirety.

The one or more processors 320 of the present disclosure may include any one or more processing elements known in the art. In this sense, the one or more processors 320 may include any microprocessor-type device configured to execute software algorithms and/or instructions. In one embodiment, the one or more processors 320 may consist of a desktop computer, mainframe computer system, workstation, image computer, parallel processor, or other computer system (e.g., networked computer) configured to execute a program configured to operate the system 300 and/or Broadband LSP light source 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium 322. Moreover, different subsystems of the various systems disclosed may include processor or logic elements suitable for carrying out at least a portion of the steps described throughout the present disclosure. Therefore, the above description should not be interpreted as a limitation on the present disclosure but merely an illustration.

The memory medium 322 may include any storage medium known in the art suitable for storing program instructions executable by the associated one or more processors 320. For example, the memory medium 322 may include a non-transitory memory medium. For instance, the memory medium 322 may include, but is not limited to, a read-only memory, a random access memory, a magnetic or optical memory device (e.g., disk), a magnetic tape, a solid state drive, and the like. In another embodiment, the memory 322 is configured to store one or more results and/or outputs of the various steps described herein. It is further noted that memory 322 may be housed in a common controller housing with the one or more processors 320. In an alternative embodiment, the memory 322 may be located remotely with respect to the physical location of the processors 320. For instance, the one or more processors 320 may access a remote memory (e.g., server), accessible through a network (e.g., internet, intranet, and the like). In another embodiment, the memory medium 322 maintains program instructions for causing the one or more processors 320 to carry out the various steps described through the present disclosure.

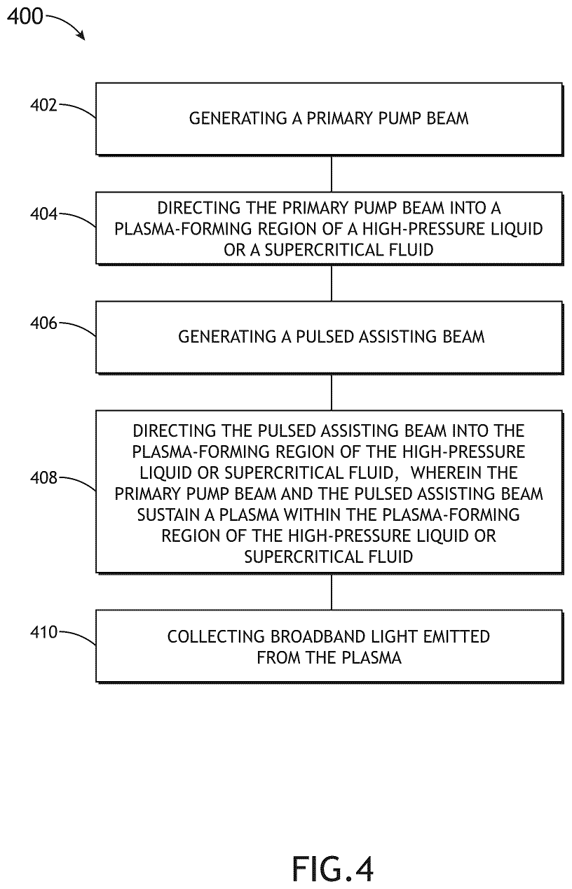

FIG. 4 illustrates a flow diagram depicting a method 400 for generating broadband light 118, in accordance with one or more embodiments of the present disclosure. It is noted herein that the steps of method 400 may be implemented all or in part by broadband LSP light source 100. It is further recognized, however, that the method 400 is not limited to the broadband LSP light source 100 in that additional or alternative system-level embodiments may carry out all or part of the steps of method 400.

In step 402, method 400 includes generating a primary pump beam. In step 404, method 400 includes directing the primary pump beam into a plasma-forming region of a fluid, wherein the fluid comprises at least one of a high-pressure liquid or a supercritical fluid. In step 406, method 400 includes generating a pulsed assisting beam. In step 408, method 400 includes directing the pulsed assisting beam into the plasma-forming region of the fluid, wherein the primary pump beam and the pulsed assisting beam are configured to sustain a plasma within the plasma-forming region of the fluid. In step 410, method 400 includes collecting at least a portion of broadband light emitted from the plasma.

One skilled in the art will recognize that the herein described components, operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A broadband light source comprising:
a fluid containment structure for containing a fluid;
a primary laser pump source, wherein the primary laser pump source is configured to direct a primary pump beam into a plasma-forming region of the fluid;
a pulsed-assisting laser source, wherein the pulsed-assisting laser source is configured to direct a pulsed-assisting beam into the plasma-forming region of the fluid, wherein the primary beam and the pulsed-assisting beam are configured to sustain a plasma within the plasma-forming region of the fluid within the fluid containment structure; and
a light collector element configured to collect at least a portion of broadband light emitted from the plasma.

2. The broadband light source of claim 1, wherein the pulsed-assisting laser source is configured to increase an instantaneous pump power above the liquid-to-gas breakdown threshold of the fluid.

3. The broadband light source of claim 1, wherein the pulsed-assisting laser source comprises a pulsed laser.

4. The broadband light source of claim 1, wherein the pulsed-assisting laser source is configured to operate at a repetition rate sufficient to avoid complete quenching of the plasma between pulses of the pulsed-assisting beam of the pulsed-assisting laser source.

5. The broadband light source of claim 1, wherein the pulsed-assisting laser source is configured to operate at a repetition rate above 0.5 MHz.

6. The broadband light source of claim 1, wherein the pulsed-assisting laser source is configured to generate pulses of less than 5 ps.

7. The broadband light source of claim 1, wherein the pulsed-assisting laser source is configured to operate at a power above 10 W.

8. The broadband light source of claim 1, wherein the laser pump source comprises a continuous-wave (CW) laser source.

9. The broadband light source of claim 8, wherein the CW laser source operates at a power above 5 kW.

10. The broadband light source of claim 1, wherein the fluid comprises at least one of a high-pressure liquid or a supercritical fluid.

11. The broadband light source of claim 1, wherein the fluid comprises at least one of water, ammonia, or one or more organic solvents.

12. The broadband light source of claim 1, wherein the fluid comprises a cryogenic liquid.

13. The broadband light source of claim 12, wherein the fluid comprises at least one of liquid Ne, liquid Ar, liquid Kr, liquid Xe, liquid N₂, or liquid O₂.

14. The broadband light source of claim 1, further comprising a recirculation pump for circulating the fluid through the fluid containment structure.

15. The broadband light source of claim 1, further comprising primary pump focusing optics configured to focus the primary pump beam into the plasma-forming region of the fluid.

16. The broadband light source of claim 1, further comprising pulsed-assisting laser focusing optics configured to focus the pulsed-assisting laser beam into the plasma-forming region of the fluid.

17. The broadband light source of claim 1, wherein at least one of primary pump focusing optics or pulsed-assisting laser focusing optics are compensated to correct for aberrations caused by the fluid containment structure.

18. A broadband light source comprising:
a fluid containment structure;
a plurality of jet nozzles, wherein the plurality of jet nozzles are configured to direct a plurality of fluid jets to collide within the fluid containment structure, wherein the plurality of fluid jets include a first fluid jet and at least a second fluid jet;
a primary laser pump source, wherein the primary laser pump source is configured to direct a primary pump beam at a collision point of the plurality of fluid jets;
a pulsed-assisting laser source, wherein the pulsed-assisting laser source is configured to direct a pulsed-assisting beam at the collision point of the plurality of fluid jets, wherein the primary beam and the pulsed-assisting beam are configured to sustain a plasma within a plasma-forming region of the fluid containment structure at the collision point of the plurality of fluid jets; and
a light collector element configured to collect at least a portion of broadband light emitted from the plasma.

19. The broadband light source of claim 18, wherein the pulsed-assisting laser source is configured to increase an instantaneous power of the plasma above the liquid-gas breakdown threshold.

20. The broadband light source of claim 18, wherein the pulsed-assisting pulsed laser source comprises a pulsed laser.

21. The broadband light source of claim 18, wherein the pulsed-assisting laser source is configured to operate at a repetition rate sufficient to avoid complete quenching of the plasma between pulses of the pulsed assisting beam of the pulsed-assisting laser source.

22. The broadband light source of claim 18, wherein the pulsed-assisting laser source is configured to operate at a repetition rate above 0.5 MHz.

23. The broadband light source of claim 18, wherein the pulsed-assisting laser source is configured to generate pulses of less than 5 ps.

24. The broadband light source of claim 18, wherein the pulsed-assisting laser source is configured to operate at a power above 10 W.

25. The broadband light source of claim 18, wherein the laser pump source comprises a continuous-wave (CW) laser source.

26. The broadband light source of claim 25, wherein the CW laser source operates at a power above 5 kW.

27. The broadband light source of claim 18, wherein one or more of the plurality of fluid jets comprise a fluid jet of at least one of water, ammonia, or one or more organic solvents.

28. The broadband light source of claim 18, wherein one or more of the plurality of fluid jets comprise a liquid jet of a cryogenic liquid.

29. The broadband light source of claim 28, wherein the cryogenic liquid comprises at least one of liquid Ne, liquid Ar, liquid Kr, liquid Xe, liquid N₂, or liquid O₂.

30. The broadband light source of claim 18, further comprising primary pump focusing optics configured to focus the primary pump beam into the plasma-forming region of the liquid.

31. The broadband light source of claim 18, further comprising pulsed-assisting laser focusing optics configured to focus the assisting pulsed laser beam into the plasma-forming region of the fluid.

32. The broadband light source of claim 31, wherein at least one of the primary pump focusing optics or the pulsed-assisting laser focusing optics comprise at least one of a lens or a mirror.

33. The broadband light source of claim 32, wherein at least one of the primary pump focusing optics or the pulsed-assisting laser focusing optics comprise one or more annular optical elements.

34. The broadband light source of claim 18, wherein the plurality of fluid jet nozzles are fluidically coupled to one or more fluid sources.

35. The broadband light source of claim 18, wherein the fluid containment structure comprise at least one of a plasma chamber, a plasma cell, or a plasma lamp.

36. A system comprising:
a broadband source comprising:
a fluid containment structure for containing a fluid;
a primary laser pump source, wherein the primary laser pump source is configured to direct a primary pump beam into a plasma-forming region of the fluid;
a pulsed-assisting laser source, wherein the pulsed-assisting laser source is configured to direct a pulsed-assisting beam into the plasma-forming region of the fluid, wherein the primary beam and the pulsed-assisting beam are configured to sustain a plasma within the plasma-forming region of the fluid within the fluid containment structure; and
a light collector element configured to collect at least a portion of broadband light emitted from the plasma;
a set of illuminator optics configured to direct the broadband light from the light collector element to one or more samples;
a detector assembly; and
a set of projection optics configured to receive illumination from the surface of the one or more samples and direct the illumination from the one or more samples to the detector assembly.

37. A system comprising:
a broadband source comprising:
a fluid containment structure;
a plurality of jet nozzles, wherein the plurality of jet nozzles are configured to direct a plurality of fluid jets to collide within the fluid containment structure, wherein the plurality of fluid jets include a first fluid jet and at least a second fluid jet;
a primary laser pump source, wherein the primary laser pump source is configured to direct a primary pump beam at a collision point of the plurality of fluid jets;
a pulsed-assisting laser source, wherein the pulsed-assisting laser source is configured to direct a pulsed-assisting beam at the collision point of the plurality of fluid jets, wherein the primary beam and the pulsed-assisting beam are configured to sustain a plasma within a plasma-forming region of the fluid containment structure at the collision point of the plurality of fluid jets; and
a light collector element configured to collect at least a portion of broadband light emitted from the plasma;
a set of illuminator optics configured to direct the broadband light from the light collector element to one or more samples;
a detector assembly; and
a set of projection optics configured to receive illumination from the surface of the one or more samples and direct the illumination from the one or more samples to the detector assembly.

38. A method comprising:
generating a primary pump beam and directing the primary pump beam into a plasma-forming region of a fluid, wherein the fluid comprises at least one of a high-pressure liquid or a supercritical fluid;
generating a pulsed assisting beam and directing the pulsed-assisting beam into the plasma-forming region of the fluid, wherein the primary pump beam and the pulsed-assisting beam are configured to sustain a plasma within the plasma-forming region of the fluid; and
collecting at least a portion of broadband light emitted from the plasma.
